(19) United States
(12) Patent Application Publication
(10) Pub. No.: US 2004/0050783 A1
(43) Pub. Date: Mar. 18, 2004

(54) Backwashing of a hollow fibre filter operating in frontal mode

(76) Inventors: Henri Barnier, Aix en Provence (FR); Jean Givaudan, St. Tulle (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/416,529

(22) PCT Filed: Dec. 4, 2001
(86) PCT No.: PCT/FR01/03823

(30) Foreign Application Priority Data
Dec. 6, 2000 (FR) 00/15808

(51) Int. Cl. B01D 65/02

(52) U.S. Cl. 210/636; 210/650; 210/321.69; 210/321.89

(57) ABSTRACT

The invention concerns the unclogging of a hollow fibre filter operating in frontal mode. Said filter comprises a filter body (1) maintaining the hollow fibres (9) in a vertical position, the liquid to be filtered being introduced into the volume of the filter body (1) via the bottom, the filtrate being evacuated via the top of the filter. The unclogging comprises a reverse injection of gas into the hollow fibres (9) and a circulation of unclogging liquid in the volume of the filter body (1), said circulation of liquid taking place from the top towards the bottom of the filter body.

### DESCRIPTION

1. Technical Field

The invention concerns a method for unclogging a hollow fibre filter operating in frontal mode. It also concerns a filtering device allowing the application of said method.

The invention makes it possible to improve the performance of this type of solid/liquid separation equipment.

2. State of the Prior Art

In frontal filtration of a suspension containing solid particles of very small dimensions, the solids/liquid separation may be carried out on filtering media in the form of hollow organic fibres under the action of a sufficient pressure to ensure the transfer of the liquid from the exterior of the fibres towards the interior of said fibres.

The fibres used, assembled in parallel in bundles in a filter body, are arranged in such a way as to be able to recover in a single circuit all of the filtered liquid. On the other hand, the solids deposited on the external surface of the fibres remain in place up to the point where their accumulation leads to a head loss that accordingly reduces the filtration pressure with, as a consequence, a drop in the production of filtered liquid. When the production of filtered liquid reaches a low predetermined threshold, the fibres have to be unclogged. This unclogging requires a stoppage of the solid/liquid separation in order to implement an appropriate unclogging technique which must make it possible to evacuate from the surface of the fibres the particles deposited on said fibres, then evacuating from the filter body all of the solids in a general purge of the system. The unclogged fibres are then able to return to their function of solid/liquid separation. It is therefore a sequential operating mode combining a filtering phase, an unclogging phase and a filter purge phase.

Hollow organic fibre filters have been used for more than twenty years in diverse fields where solid/liquid separation needs exist. They have the advantage of a large filtering area coupled with a small size.

The organic fibres are available in various materials (PVA or polyvinyl alcohol, PS or polysulphone, etc.) and are obtained by drawing in the following approximate dimensions:

external diameter between 0.3 and 3 mm,

internal diameter between 0.15 and 2 mm,

length on demand, up to several metres.

The fibres are assembled in clusters or bundles of several thousand fibres with equal length. They may be maintained at one end and plugged at the other end, which remains free. They may also be maintained at both of their ends, which remain free. The two ends of the fibres may be opposite (straight fibres) or situated on the same level (U shaped fibres).

The fibres are porous, with pore diameters dₚ allowing the integral stoppage of the smallest particles present in the fluid to be treated (typically, dₚ is greater than or equal to 0.1 μm). In liquid medium, a “bubble point pressure” measurement makes it possible to reach this average dimension dₚ, whereby the lower the dₚ, the higher the bubble point air pressure.

The clusters or bundles of fibres are assembled individually or in parallel in suitable casings or filter bodies capable of ensuring the admission under pressure (less than or equal to 3 bar) of the fluid to be filtered via the bottom or via the top. The filter body also makes it possible to ensure the evacuation of the filtered fluid, it being understood that there exists on the filter body, through its design, a total cut-off of the input circuit of the fluid to be filtered and the evacuation circuit of the filtered fluid.

At the lower predetermined set point for the production of filtered liquid, the unclogging of this type of filter is carried out either by reverse injection of filtered liquid for sufficient time to cause the release of the solid particles from the surface of the fibres, or by reverse injection of pressurised gas for an equivalent time (see the U.S. Pat. No. 4,540,490). The reverse injection signifies that, for a short time, a liquid or gaseous fluid circulates in the opposite direction to the normal direction of filtration, thus from the interior of the fibres towards the exterior of said fibres under the action of a sufficient mechanical pressure. In the case of a reverse injection of liquid, said pressure may be low, medium or high. In the case of a reverse injection of gas (air or nitrogen for example), said pressure must be greater than the bubble point pressure of the fibres, which depends on the pore diameter dₚ.

In the method of unclogging by reverse injection of gas, for a filter body in a vertical position, there is then an ascension of bubbles of gas on the external face of the fibres which are in a liquid phase containing the solids displaced from the surface of the fibres. The purge of the solids/liquid mixture contained in the filter body, which follows the unclogging phase, is favoured by a vertical positioning of the filter body and by an assembly of fibres where only the upper part of said fibres is maintained in the body, the lower part remaining free. This type of purge is put at a disadvantage by any other assembly.

Said method of unclogging must be carried out in the minimum amount of time, with a low frequency, while at the same time leading to a maximum elimination of the solids deposited on the fibres. If this is not the case, a loss of productivity and a residual clogging result which, accumulated sequence after sequence, necessitates in the long term a chemical cleaning of the fibres. This type of chemical cleaning is restrictive and produces secondary effluents. By way of indication, the cleaning must be carried out once per day. The whole skill of the operator therefore consists in properly controlling the filtration (by its specific parameters) and the unclogging by reverse injection.

The adhesion of the particles on the surface of the fibres depends on numerous parameters. One may cite, in particular, the following factors:

the nature of the particles and the nature of the fibres (particle-surface interactions),

the saline composition of the liquid containing the particles (low salinity being favourable to the adhesion of the particles on the fibres) or the specific chemical characteristic of the same liquid (pH),

the mechanical pressure of filtration (high pressures favour the incrustation or the penetration of the particles into the porous fibres).

The additional adhesion of particles on a first layer of particles, depending on the same parameters, results in a “cake” type structure.

The evacuation of the particles or the cake deposited on the surface of the fibres is then the result of various mechanical actions that occur between the surface of the fibres and the first layer of particles, induced by the forced passage of a liquid or gaseous fluid, then by the ascension of bubbles of gas within the bundles of fibres in the latter case.

The more rapid the purge and the more there is a certain liberty of movement at the level of the fibres, the more efficient the evacuation of particles or broken up cake during the purge.

### DESCRIPTION OF THE INVENTION

The present invention has been conceived to allow a particularly efficient and rapid evacuation of particles or cake deposited on the surface of hollow fibres.

The aim of the present invention is a method for unclogging a hollow fibre filter operating in frontal mode, said filter comprising a filter body maintaining the hollow fibres in a vertical position, the liquid to be filtered being introduced into the volume of the filter body via the bottom, the filtrate being evacuated via the top of the filter, the unclogging method comprising a reverse injection of gas into the hollow fibres, characterised in that it also comprises a circulation of unclogging liquid in the volume of the filter body, said circulation of liquid taking place from the top towards the bottom of the filter body.

Advantageously, said circulation of unclogging liquid consists in circulating the liquid to be filtered remaining in the filter body thanks to a circuit connected in parallel on the filter body.

The unclogging liquid may circulate at a flow rate that allows the temporary sweeping along of bubbles of the gas reverse injected into the hollow fibres.

Preferably, the unclogging phase is consecutive to the attainment of a predetermined set point chosen among a minimum filtration flow rate set point and a maximum cumulated volume of filtrate set point.

According to a specific embodiment, the unclogging phase comprises the following steps:

stopping the introduction of the liquid to be filtered into the filter body,

then, applying an external pressure from the top of the filter,

then, reverse injecting gas into the hollow fibres at a pressure higher than the bubble point pressure, and

simultaneously circulating the unclogging liquid.

The reverse injected gas may be chosen from among air, nitrogen and the other neutral gases.

Advantageously, the method comprises an additional final step consisting in emptying the filter body.

Another aim of the present invention is a filtering device comprising a hollow fibre filter operating in frontal mode, said filter comprising a filter body maintaining the hollow fibres in a vertical position, the filter body comprising means of introduction of the liquid to be filtered into the volume of the filter body, said means of introduction being located in the bottom of the filter body, the filter comprising means of evacuation of the filtrate and reverse injection of an unclogging gas located in the top of the filter body, characterised in that the device comprises a circuit to aid the unclogging of the hollow fibres, said circuit allowing an introduction of unclogging liquid into the top of the volume of the filter body and its evacuation via the bottom of the filter body.

Preferably, the hollow fibres are maintained uniquely by their upper ends.

The filter body may comprise a flow splitting device making it possible to distribute the liquid to be filtered in the volume of the filter body. Such a flow splitting device has the advantage of causing a partial “umbrella-like” opening of the bundle of fibres, which favours a homogeneous distribution of the liquid introduced on the fibres and avoids a localised accumulation of particles on several peripheral fibres.

Preferably, the unclogging aid circuit is a circuit connected in parallel on the filter body and making it possible to circulate, during an unclogging phase, the liquid to be filtered remaining in the filter body. Said unclogging aid circuit may comprise an opening/closing valve, for example a diaphragm valve, and a pump that may be chosen from among centrifuge, peristaltic and vortex type pumps.

### BRIEF DESCRIPTION OF THE DRAWINGS

The invention will be more clearly understood and other advantages and specific features will become apparent on reading the description that follows, given by way of example and in nowise limitative, and by referring to the appended drawings, amongst which:

FIG. 1 is a schematic vertical section of a filtering device according to the invention, represented in filtering phase.

FIG. 2 is a schematic vertical section of the filtering device corresponding to FIG. 1 but represented in unclogging phase.

### DETAILED DESCRIPTION OF AN EMBODIMENT OF THE INVENTION

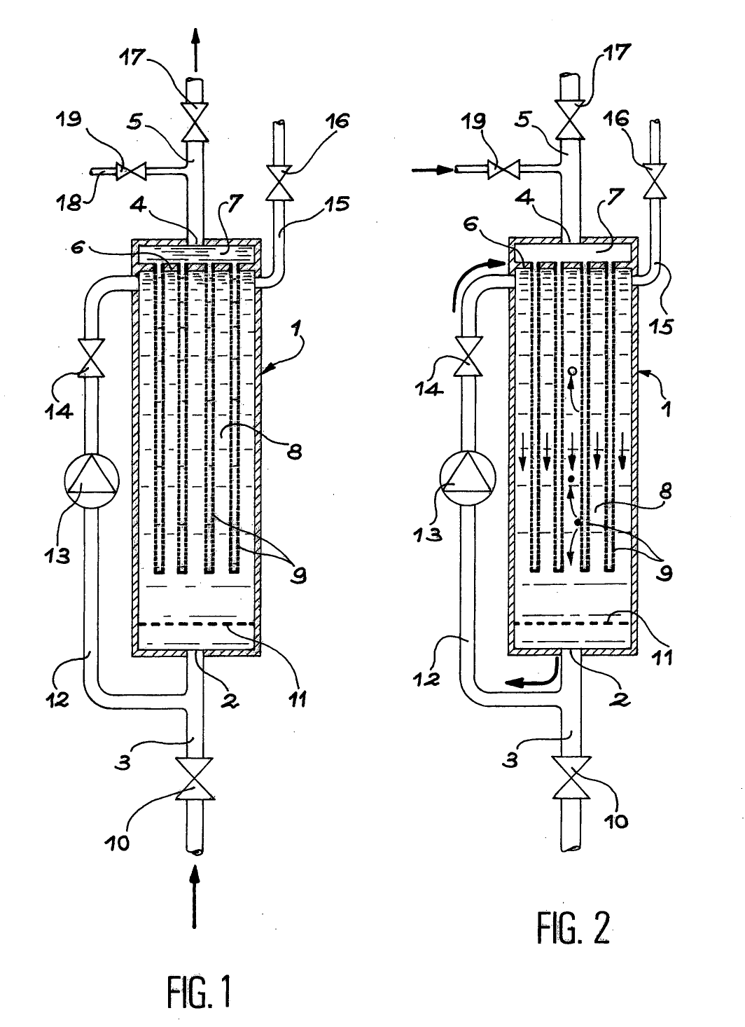

The filtering device represented in FIG. 1 comprises a filter body 1 in the form of a vertical cylinder sealed at its ends. Its lower end comprises an orifice 2 connected to a pipe 3 for introducing the liquid to be filtered. Its upper end comprises an orifice 4 connected to a pipe 5 for evacuating the filtrate. Said pipe 5 is equipped with a valve 17. Between said valve 17 and the evacuation orifice 14, a pipe 18, equipped with a valve 19, is connected to said pipe 5.

The upper part of the filter body 1 is provided with a plate 6 dividing the filter body into an evacuation chamber 7, leading to the evacuation orifice 4, and a larger part 8, called the volume of the filter body. Said plate 6 maintains a bundle of hollow fibres 9, of which only several have been represented. The fibres are plugged at their lower ends. The external surface of the hollow fibres is thus in contact with the liquid to be filtered, which is introduced into the volume 8 of the filter body while the input valve 10 is open. The interior of the hollow fibres 9 communicates with the evacuation chamber 7.

The lower part of the filter body 1 comprises a fluid flow splitting device 11 which delivers a flow of homogeneous liquid on the hollow fibres 9. Said fibres being flexible and only maintained by their upper ends, the flow of liquid to be filtered causes the partial “umbrella-like” opening of the bundle of fibres.

The filter according to the invention moreover comprises a circuit connected in parallel on the filter body. Said circuit principally comprises a pipe 12 connected, in its lower part, to the pipe 3 for introducing the liquid to be filtered, between the orifice 2 and the input valve 10. The pipe 12 is connected, in its upper part, to the filter body 1, just underneath the plate 6. It is equipped with a pump 13 and a valve 14. Said pump 13 may be a centrifuge, peristaltic or vortex type pump. The valve 14 is, for example, a diaphragm type valve.

A vent pipe 15 equipped with a valve 16 is connected to the upper part of the filter body 1, just underneath the plate 6.

In filtering phase, the pump 13 is stopped and the valves 14, 16 and 19 are closed. The valve 10 being open, the liquid to be filtered is introduced via the pipe 3 into the filter body 1. The filtrate coming from the interior of the hollow fibres 9 opens out into the evacuation chamber 7 and is evacuated via the pipe 5.

The order to unclogging of the hollow fibres may be slaved to two specific set points: one set point for the minimum filtration flow rate or another set point for the cumulated volume of filtrate. This second set point makes it possible to control the quantity of solids deposited per unit of filtering area.

One or the other of the unclogging set points leads to:

the stoppage of the admission of the fluid to be filtered by closing of the valve 10,

the closing of the valve 17,

the opening of the filter body vent by the opening of the valve 16,

the opening of the valve 19 for the reverse injection of a gas (air or nitrogen) via the pipe 18 and the section of pipe 5 connected to the orifice 4, the gas being at a slightly higher pressure than the bubble pressure,

the opening of the valve 14 and the start up of the pump 13 for the re-circulation of the void volume of fluid in the filter body 1.

The reverse injection of gas and the re-circulation of the fluid are two operations that are advantageously simultaneous.

A circulation of a liquid-solid-gas mixture then occurs in the filter body and in the by-pass circuit. The pump 13 allows an average descending speed of the liquid and the solids of around 4 to 5 cm/s to be obtained in the filter body and at the level of the fibres. There exists, in the filter body, at the level of the hollow fibres, a displacement of gas bubbles that may be temporarily ascending or descending depending on the size of the bubbles. There is inter-particle friction or impact between the free particles and the particles still adhering to the surface of the fibres. An agitation of the fibres between themselves occurs as a result of the various circulations of fluids.

All of these consequences lead to a better release of the particles from the surface of the fibres under the action of various stresses (or gradients) due to the liquid and/or to the gas, under the action of interparticle friction.

After a sufficient unclogging time (several minutes), the purge of the filter body is carried out under conditions known to those skilled in the art by emptying the filter body. The filtering phase is started up again after filling the filter body by the liquid to be filtered.

Compared to the unclogging techniques of the prior art mentioned above, it appears that the invention makes it possible to extend the frequency of chemical unclogging from one day to one week, which demonstrates the efficiency of the invention.

1. A method for unclogging a hollow fibre filter operating in frontal mode, the filter comprising a filter body (1) maintaining the hollow fibres (9) in a vertical position, the liquid to be filtered being introduced into the volume of the filter body (1) via the bottom, the filtrate being evacuated via the top of the filter, the unclogging method comprising a reverse injection of gas into the hollow fibres (9), characterised in that it also comprises a circulation of unclogging liquid in the volume of the filter body (1), said circulation of liquid taking place from the top towards the bottom of the filter body.

2. The method for unclogging according to claim 1, characterised in that said circulation of unclogging liquid consists in circulating the liquid to be filtered remaining in the filter body (1) thanks to a circuit (12) connected in parallel on the filter body (1).

3. The method for unclogging according to claim 1, characterised in that the unclogging liquid circulates at a flow rate that allows the temporary sweeping along of bubbles of gas reverse injected into the hollow fibres (9).

4. The method for unclogging according to claim 1, characterised in that the unclogging phase is consecutive to the attainment of a predetermined set point chosen among a minimum filtration flow rate set point and a cumulated volume of filtrate set point.

5. The method for unclogging according to claim 1, characterised in that the unclogging phase comprises the following steps:
stopping the introduction of the liquid to be filtered into the filter body (1),
then, applying an external pressure from the top of the filter,
then, reverse injecting gas into the hollow fibres (9) at a pressure higher than the bubble point pressure, and
simultaneously circulating the unclogging liquid.

6. The method for unclogging according to claim 1, characterised in that the reverse injected gas is chosen from among air, nitrogen and the other neutral gases.

7. The method for unclogging according to claim 1, characterised in that it comprises an additional final step consisting in emptying the filter body (1).

8. A filtering device comprising a hollow fibre filter operating in frontal mode, said filter comprising a filter body (1) maintaining the hollow fibres (9) in a vertical position, the filter body (1) comprising means of introduction (2) of the liquid to be filtered into the volume of the filter body (1), said means of introduction (2) being located in the bottom of the filter body (1), the filter comprising means of evacuation (4) of the filtrate and reverse injection of an unclogging gas located in the top of the filter body (1), characterised in that the device comprises a circuit (12) to aid the unclogging of the hollow fibres (9), said circuit allowing an introduction of unclogging liquid into the top of the volume of the filter body (1) and its evacuation via the bottom of the filter body.

9. The filtering device according to claim 8, characterised in that the hollow fibres (9) are maintained uniquely by their upper ends.

10. The filtering device according to claim 8, characterised in that the filter body (1) comprises a flow splitting device (11) making it possible to distribute the liquid to be filtered in the volume of the filter body.

11. The filtering device according to claim 8, characterised in that the top of the filter body (1) is connected to a vent.

12. The filtering device according to claim 8, characterised in that the unclogging aid circuit is a circuit (12) connected in parallel on the filter body (1) and making it possible to circulate, during an unclogging phase, the liquid to be filtered remaining in the filter body (1).

13. The filtering device according to claim 12, characterised in that the unclogging aid circuit comprises an opening/closing valve (14) and a pump (13).

14. The filtering device according to claim 13, characterised in that the pump (13) is chosen from among centrifuge, peristaltic and vortex type pumps.

15. The filtering device according to claim 13, characterised in that the valve (14) is a diaphragm valve.
